(19) United States
(12) Patent Application Publication
(10) Pub. No.: US 2008/0104716 A1
(43) Pub. Date: May 1, 2008

(54) Apparatus for improved security and connectivity of a computer display and other secured items

(76) Inventor: Michael Hall, Santa Cruz, CA (US)

Correspondence Address: MURABITO, HAO & BARNES, LLP, TWO NORTH MARKET STREET, THIRD FLOOR, SAN JOSE, CA, 95113, US

(21) Appl. No.: 11/655,699

(22) Filed: Jan. 19, 2007

Related U.S. Application Data
(63) Continuation-in-part of application No. 11/497,471, filed on Jul. 31, 2006.

(51) Int. Cl. G06F 21/00

(52) U.S. Cl. 726/34

(57) ABSTRACT

An apparatus for improving the security and connectivity of secured items. Embodiments are directed to an apparatus for securing a computer display in addition to other items (e.g., portable devices, portable storage devices, desk items, etc.). The computer display may be placed within a channel of the apparatus and secured using a cover, door, or the like, where the cover may be dedicated to securing the display or used to secure items within another compartment of the apparatus in addition to the display. Alternatively, the computer display may be secured to the housing of the apparatus such that the apparatus functions as a base for the computer display. Additionally, the apparatus may include one or more compartments for storing additional items, where the compartments may be accessible by a securable cover, door, drawer, etc.

### RELATED APPLICATIONS

This patent application is a continuation-in-part application of co-pending, commonly-owned U.S. patent application Ser. No. 11/497,471, filed on Jul. 31, 2006, entitled “APPARATUS AND SYSTEM FOR IMPROVING COMPUTER SYSTEM SECURITY”, naming Michael Hall as the inventor, which is hereby incorporated herein by reference.

### BACKGROUND OF THE INVENTION

As technology advances, the capabilities and features of portable devices are continuing to increase. For example, portable devices will now store and play music, videos and other media. Hand-held computers now offer significant processing power rivaling desktop systems of the recent past. Additionally, portable storage devices continue to shrink in size, yet are capable of holding increasing amounts of information. And even computer displays are becoming lighter and more portable despite increases in viewable area. As such, consumers are willing to pay higher and higher prices for these devices given their increasing utility.

As the value of these devices increases, the demand for adequate security measures is also increasing. Additionally, the increased reliance upon these devices is also fueling the desire for improved security. For example, many people use portable devices to plan their day, organize contacts, set reminders, check and send email, store confidential information, store and playback music, view graphical applications, experience audio and/or video content (e.g., television, videos, etc.), and the like. As such, theft or even unauthorized access to such devices may compromise day-to-day functionality, confidential information, etc.

When at work, at school or otherwise at a workstation, conventional security measures involve storing valuables in locked drawers. Although locking a valuable device in a drawer may provide security, it creates a serious inconvenience as the device must be removed for use. And given the frequency with which an average person leaves and returns to a workspace, repeated securing and unsecuring increases the likelihood that the device may unintentionally be left unsecured. Thus, conventional solutions are inconvenient and compromise both the device and the information contained thereon.

And in some cases, security measures do not exist to secure certain items. For example, computer displays are often set on a desk or workstation in unsecured fashion. As such, the display may be borrowed or stolen at will, thereby leaving the user without access to computer system information and functionality.

### SUMMARY OF THE INVENTION

Accordingly, a need exists for improved security measures for portable devices and the information contained thereon. Additionally, a need exists for a more convenient means of securing portable devices. Further, a need exists for a way to secure portable devices that reduces the number of times the device must be unsecured for use. Additionally, a need exists for an effective and convenient way to secure computer displays. Embodiments of the present invention provide novel solutions to these needs and others as described below.

Embodiments of the present invention are directed to an apparatus for improving the security and connectivity of secured items. More specifically, embodiments are directed to an apparatus for securing a computer display in addition to other items (e.g., portable devices, portable storage devices, desk items, etc.). The computer display may be placed within a channel of the apparatus and secured using a cover, door, or the like, where the cover may be dedicated to securing the display or used to secure items within another compartment of the apparatus in addition to the display. Where a dedicated cover is used, the mechanism for securing the cover may be configured to release the cover only upon access to another secured compartment of the apparatus. Where the cover is used to secure both a computer display and other items within a compartment, the channel for accepting the base of the computer display may be accessible primarily from the compartment such that the cover can be opened and/or removed before the display is inserted or removed from the apparatus.

In another embodiment, the computer display may be secured to the housing of the apparatus such that the apparatus functions as a base for the computer display. The housing may comprise a surface with engagement features (e.g., holes, tabs, hooks, etc.) for interfacing with respective features on the computer display. The surface may interface with one or more monitors (e.g., providing a “universal” display mounting). Alternatively, the surface for mounting the computer display may be detachably coupled to the housing such that it may be replaced with other surfaces for interfacing with other computer displays. Further, the mounting features may be configured such that the computer display may be separated from the apparatus only when the apparatus is placed in an unsecured state.

In addition to the ability to secure a computer display base, the apparatus may include one or more compartments for storing additional items. The compartments may be accessible by a cover, door, drawer, etc. that may be secured to the housing of the apparatus with a lock mechanism or the like. Additionally, one or more of the compartments may comprise at least one interface for coupling a secured item to an external system, external device, external component, etc. The item may be coupled (e.g., plugged in) to the interface before placing the compartment in a secured state (e.g., to limit physical access to the item), where a portion of the interface accessible from the outside of the apparatus provides electrical access to the item (e.g., to communicate with the item, to provide power to the item, etc.) when in the secured state. Thus, embodiments provide effective and convenient security for a variety of items used in or around a desk and/or workspace.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary security device in accordance with one embodiment of the present invention.

FIG. 2 shows an exemplary security device with a door for securing a computer display in an unsecured state in accordance with one embodiment of the present invention.

FIG. 3 shows an exemplary security device with a door for securing a computer display in a secured state in accordance with one embodiment of the present invention.

FIG. 4 shows a computer display placed within an exemplary security device in an unsecured state in accordance with one embodiment of the present invention.

FIG. 5 shows a computer display placed within an exemplary security device in a secured state in accordance with one embodiment of the present invention.

FIG. 6 shows an exemplary security device with a lower-profile door for securing a computer display in accordance with one embodiment of the present invention.

FIG. 7 shows an exemplary security device in an unsecured state in accordance with one embodiment of the present invention.

FIG. 8 shows a compartment for securing items and a cover for at least partially obscuring access to a passage way into the compartment in accordance with one embodiment of the present invention.

FIG. 9 shows a first exemplary orientation of the cover for partially obscuring access to the passage way into the compartment in accordance with one embodiment of the present invention.

FIG. 10 shows a second exemplary orientation of the cover for obscuring access to the passage way into the compartment in accordance with one embodiment of the present invention.

FIG. 11 shows an exemplary security device with a first rotatably-coupled cover for securing items in accordance with one embodiment of the present invention.

FIG. 12 shows an exemplary security device with a second rotatably-coupled cover for securing items in accordance with one embodiment of the present invention.

FIG. 13 shows an exemplary security device with a surface for mounting a computer display in accordance with one embodiment of the present invention.

FIG. 14 shows exemplary engagement features of a computer display for interfacing with a surface of a security device in accordance with one embodiment of the present invention.

FIG. 15 shows a computer display mounted to an exemplary security device in accordance with one embodiment of the present invention.

FIG. 16 shows an exemplary security device with a channel for accepting a computer display which is accessible from a compartment of the exemplary security device in accordance with one embodiment of the present invention.

FIG. 17 shows a computer display placed within a channel for accepting the computer display which is accessible from a compartment of the exemplary security device in accordance with one embodiment of the present invention.

FIG. 18 shows a computer display secured within a channel for accepting the computer display which is accessible from a compartment of the exemplary security device in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

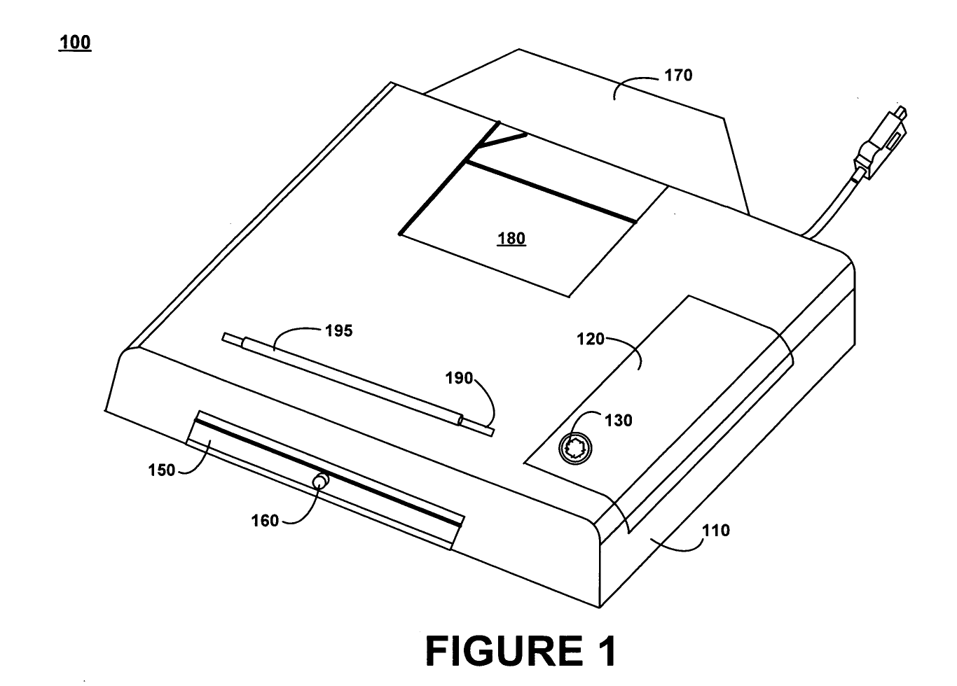

FIG. 1 shows exemplary security device 100 in accordance with one embodiment of the present invention. As shown in FIG. 1, security device 100 may be placed on a workstation (e.g., desk, etc.) surface and used to store and/or secure items (e.g., portable computing devices, portable media devices, cellular phones, portable storage devices, password listings, etc.) in multiple areas. For example, items may be placed within housing 100 beneath cover 120 and secured with lock mechanism 130. Additionally, items may be placed within drawer 150 and secured with lock mechanism 160. As such, physical access to items may be limited by cover 120 and drawer 150. And further, door 170 may be opened to enable a computer display to be placed within opening or channel 180 of housing 110 (e.g., such that the display support protrudes from opening 185 of housing 110), where securing door 170 to housing 110 effectively secures the computer display.

In addition to securable compartments, security device 100 comprises organizational feature 190 for locating item 195. In one embodiment, feature 190 may be a groove in housing 110 for controlling movement of item 195. Additionally, item 195 may comprise a writing device (e.g., a pen, pencil, etc.) or other item for which quick access is desired.

Lock mechanisms 130 and/or 160 may comprise any locking technology enabling a user to toggle between one or more security states (e.g., corresponding to privilege levels) using a user interface and/or user control associated with the locking mechanism. For example, the locking mechanism may be mechanical (e.g., key-actuated, combination, etc.), electrical (e.g., voice activated, etc.), optical (e.g., fingerprint activated, use eye-related recognition, etc.), etc.

Although FIG. 1 depicts a security device (e.g., 100) with only three areas (e.g., beneath cover 120, drawer 150 and channel 180) for securing items, it should be appreciated that a larger or smaller number of areas may be used to secure items in other embodiments. Additionally, it should be appreciated that device 100 may comprise more than one organizational feature (e.g., in addition to or in place of feature 190) in other embodiments. And further, it should be appreciated that the areas used to secure items and/or the features used to locate items may be sized and/or shaped differently in other embodiments.

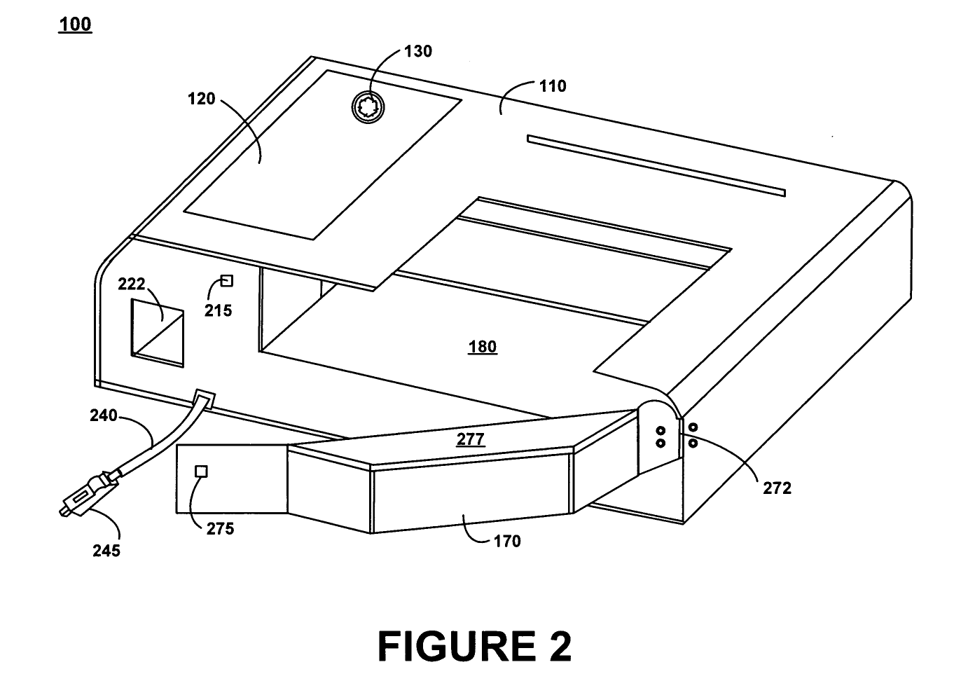

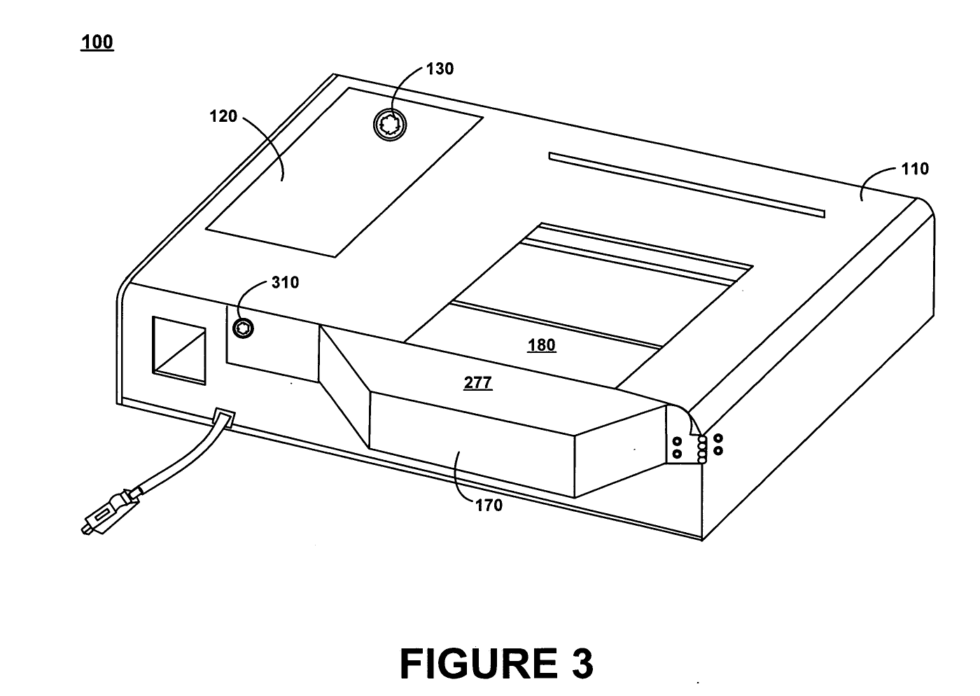

FIG. 2 shows exemplary security device 100 with door 170 for securing a computer display in an unsecured state in accordance with one embodiment of the present invention, while FIG. 3 shows exemplary security device 100 with door 170 for securing a computer display in a secured state in accordance with one embodiment of the present invention. Door 170 is rotatably-coupled with housing 110 via hinge mechanism 272. Door 170 may be rotated open to accept the base of a computer display in opening or channel 180 as depicted in FIG. 2. After inserting the display, door 170 may be rotated shut against housing 110 (e.g., as shown in FIG. 3) such that door engagement feature 275 aligns with housing engagement feature 215. Once aligned, fastening member 310 may be inserted through the engagement features (e.g., 275 and 215) to engage door 170 with housing 110 and secure the computer display placed within channel 180.

Fastening member 310 may comprise a screw, bolt, pin, or other fastening mechanism. In one embodiment, when member 310 is inserted into housing 110 as shown in FIG. 3, a portion of member 310 (e.g., threads for accepting a nut, a hole for accepting a pin, etc.) for releasing door 170 from its secured state may only be accessible via cover 120. As such, door 170 may be released after placing cover 120 and lock mechanism 130 in an unsecured state, thereby providing access to the portion of member 310 for releasing door 170. Accordingly, a lock mechanism is not required for door 170, thereby reducing the cost and complexity of device 100.

As shown in FIGS. 2 and 3, door 170 comprises bulge 277. Bulge 277 increases the volume of channel 180 when door 170 is placed in a secured state, thereby enabling security device 100 to accommodate computer displays with larger bases.

As shown in FIG. 2, security device 100 comprises interface 240 for coupling items stored and/or secured within housing 110 (e.g., beneath cover 120, in drawer 150, etc.) to an external system, external device, external component, etc. For example, once a portable device stored within device 100 is coupled to interface 240 (e.g., via a plug coupled to interface 240 and accessible from within a secured compartment of device 100), interface 240 may be used to communicate with, charge, or otherwise interact with (e.g., via interface plug 245) the portable device when device 100 placed in a secured state. Thus, interface 240 provides electrical access to an item secured within device 100 when physical access to the secured item is limited (e.g., by cover 120, lock mechanism 130, drawer 150, lock mechanism 160, etc.).

Interface 240 may comprise an interface bus in accordance with such standards as USB, USB 2.0, IEEE 1394, PCI-Express, SATA, Ethernet, etc., thereby enabling the transfer of media (e.g., music, video, etc.) and/or other data. The interface bus may also form a control bus for providing external control of a secured device. In one embodiment, an external controller (e.g., keys on a computer keyboard, a device with audio inputs and/or outputs, a device with visual inputs and/or outputs, etc.) may be coupled to interface 240 to control, interact with and/or otherwise use an item secured in device 100. Alternatively, interface 240 may comprise an analog signaling bus (e.g. for transferring analog signals (e.g., music, video, etc.) to and from a secured item. And in another embodiment, interface 240 may provide power (e.g., alternative current (AC), direct current (DC), etc.) to an item secured within device 100, where the power may be used to operate a portion of the secured item, charge a power source of the secured item, etc.

Security device 100 also comprises passage way 222 in housing 110 for routing interfaces into secured compartments. As such, electrical interfaces (and any associated plugs, connectors, etc.) may be routed through passage way 222 and coupled to secured items (e.g., when device 100 is in an unsecured state) for communicating with, providing power to, or otherwise interacting with the secured devices. As discussed above with respect to interface 240, it should be appreciated that the electrical interfaces routed through passage way 222 may utilize analog or digital signaling. Alternatively, power (e.g., AC, DC, etc.) may be routed through passage way 222. As such, device 100 offers various means for providing electrical access to secured items while physical access is limited.

Although FIGS. 2 and 3 depict door 170 with a specific shape (e.g., with bulge 277), door 170 may be alternatively shaped (e.g., with no bulge, with a larger or smaller bulge, etc.) in other embodiments. Additionally, although FIGS. 2 and 3 depict door 170 as rotatably coupled via hinge mechanism 272, it should be appreciated that door 170 may alternatively couple (e.g., with slots in housing 110 and tabs on door 170, with tabs on housing 110 and slots in door 170, with fasteners on both ends of door 170, etc.) to housing 110 in other embodiments. Further, it should be appreciated that passage way 222 may be alternatively sized, shaped or located in other embodiments. And in other embodiments, a larger or smaller number of passage ways may be used.

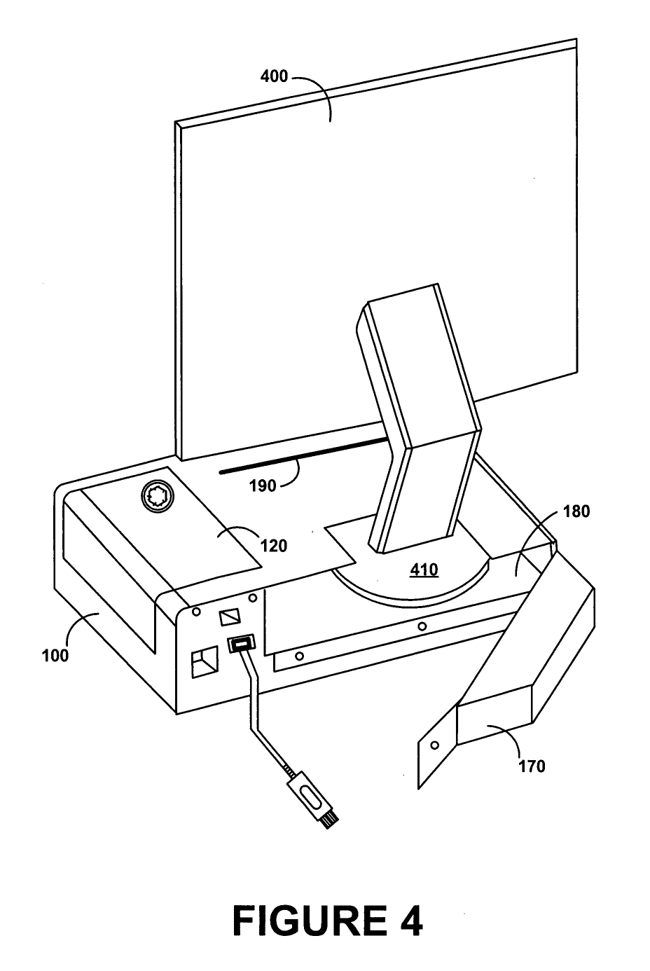

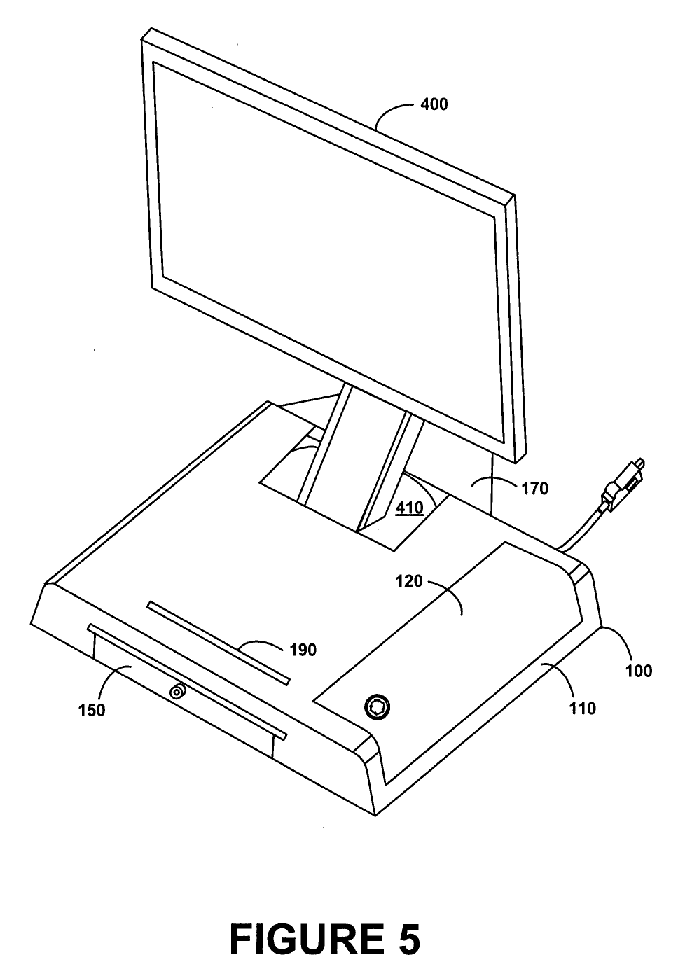

FIG. 4 shows computer display 400 placed within exemplary security device 100 in an unsecured state in accordance with one embodiment of the present invention, while FIG. 5 shows computer display 400 with base 410 placed within exemplary security device 100 in a secured state in accordance with one embodiment of the present invention. As shown in FIG. 4, door 170 may be opened and base 410 of display 400 may be placed on a surface of channel 180 within device 100. Door 170 may then be closed and secured to housing 110 as shown in FIG. 5, thereby securing display 400 within device 100. As such, device 100 forms a secondary base (e.g., in addition to base 410) for display 400 when secured therein.

As shown in FIGS. 4 and 5, device 100 is configured to make effective use of workspace area on the workstation, desk, etc. on which device 100 is placed. For example, device 100 essentially reuses the area that is ordinarily occupied by base 410 (e.g., when placed directly on the workstation surface) by providing drawer 150 for securing items below base 410 and organizational feature 190 for locating more commonly-accessed items above base 410. Additionally, the storage compartment to the side of base 410 (e.g., covered by cover 120) occupies workspace area which may ordinarily be unusable when overhung with a wide display (e.g., wider than display 400). Thus, device 100 provides effective and convenient security (e.g., offering easy access to many different items, electrical access to secured items, etc.) while reducing the amount of workspace area occupied beyond that of the display footprint itself.

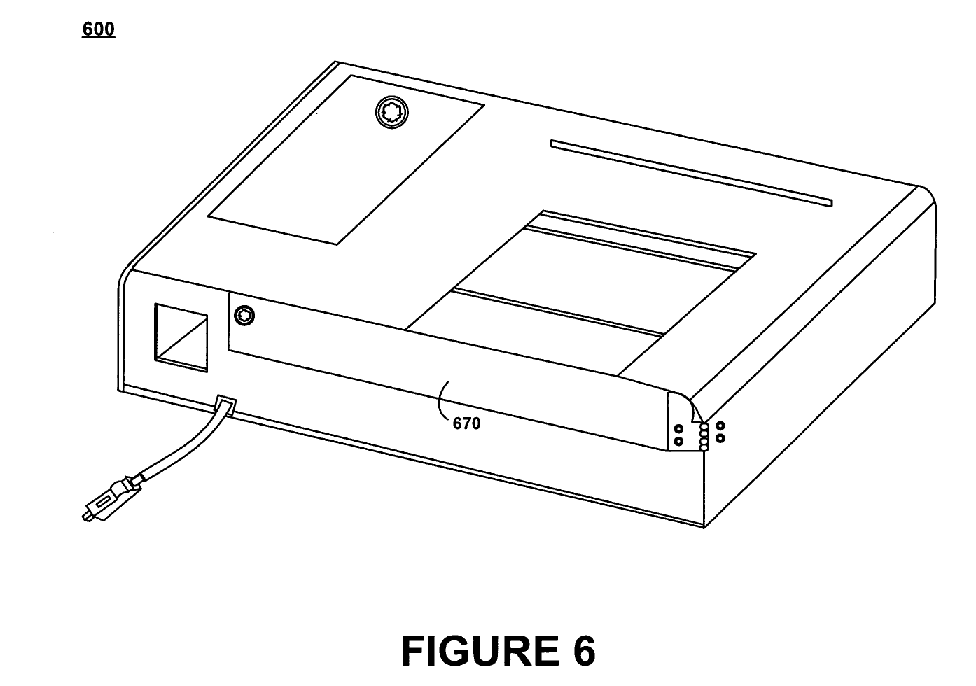

FIG. 6 shows exemplary security device 600 with a lower-profile door for securing a computer display in accordance with one embodiment of the present invention. As shown in FIG. 6, door 670 is substantially flat (e.g., without bulge 277 of door 170) for further reducing the workspace area occupied by the security device. It should be appreciated that door 670 may be alternatively shaped in other embodiments.

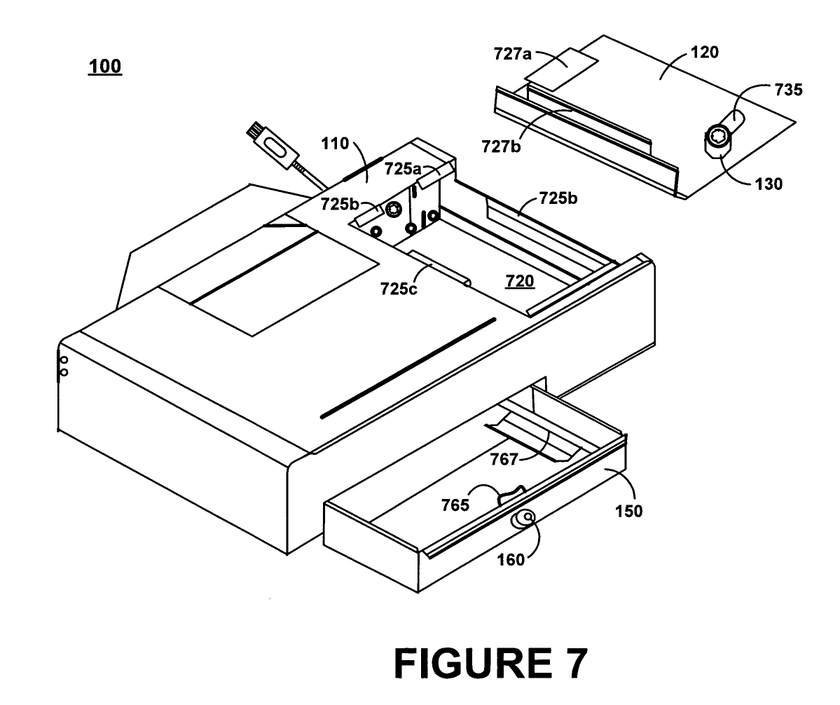

FIG. 7 shows exemplary security device 100 in an unsecured state in accordance with one embodiment of the present invention. As shown in FIG. 7, cover 120 has been disengaged from housing 110 to reveal compartment 720 for storing and/or securing items. Additionally, FIG. 7 shows engagement features 727a and 727b of cover 120 for interfacing (e.g., when cover 120 is placed on housing 110) with corresponding engagement features 725a and 725b of housing 110. Housing 110 also has additional engagement feature 725c for supporting cover 120 when placed in a secured state. Accordingly, once the engagement features of housing 110 and cover 120 are brought into contact, lock mechanism 130 may be placed in a secured state (e.g., engaging lock arm 735 with a corresponding engagement feature coupled to housing 110) to limit movement of cover 120 with respect to housing 110 and secure items placed within compartment 720.

Additionally, drawer 150 has been pulled out from housing 110 to receive items to be secured. Drawer 150 comprises clip 767 for holding down papers (e.g., password listings, etc.) or other thin items. As such, once items are placed within drawer 150, drawer 150 may be shut and lock mechanism 160 may be placed in a secured state (e.g., engaging lock arm 765 with a corresponding engagement feature coupled to housing 110) to limit movement of drawer 150 with respect to housing 110 and secure items placed within drawer 150.

Although FIG. 7 depicts tab-like engagement features for locating, supporting and securing cover 120 to housing 110, it should be appreciated that other engagement features (e.g., a hinge mechanism in place of features 725a and 727a) may be used in other embodiments. Additionally, although lock arms 735 and 765 are depicted in FIG. 7 for engaging housing 110, it should be appreciated that other engagement mechanisms may be used in other embodiments. And it should also be appreciated that additional and/or alternative organizational features (e.g., dividers, leashes, ties, pouches, etc.) may be used in drawer 150 to organize and/or restrain secured items in other embodiments. Further, although interfaces and/or cables are not shown in drawer 150, it should be appreciated that interfaces and/or cables similar to that of compartment 720 may be routed into drawer 150.

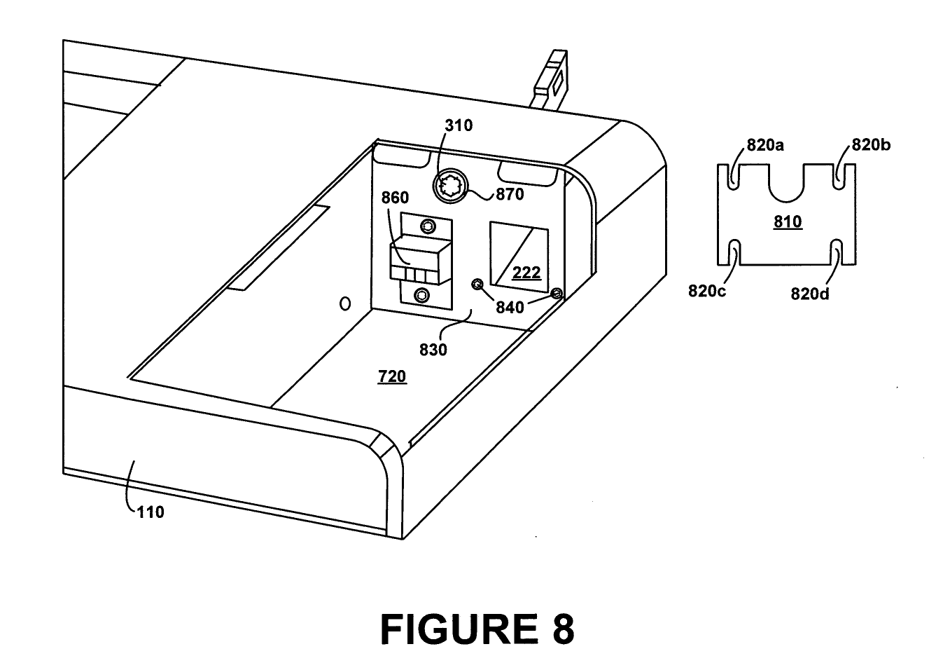

FIG. 8 shows compartment 720 for securing items and cover 810 for at least partially obscuring access to passage way 222 into compartment 720 in accordance with one embodiment of the present invention. As shown in FIG. 8, cover 810 comprises mounting features 820a-820d for mounting cover 810 to surface 830 via mounting features 840 of housing 110. In one embodiment, mounting features 840 may comprise threaded studs with nuts (e.g., hex nuts, wing nuts, etc.) for tightening down against cover 810. In other embodiments, other mounting features may be used. Additionally, mounting features 820a-820d may be alternatively configured (e.g., as holes in cover 810, etc.).

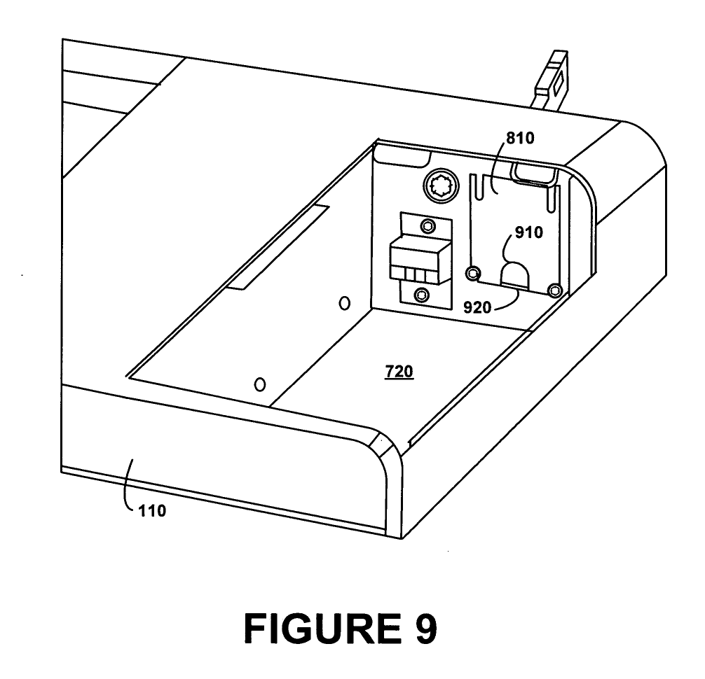

FIG. 9 shows a first exemplary orientation of cover 810 for partially obscuring access to passage way 222 into compartment 720 in accordance with one embodiment of the present invention. As shown in FIG. 9, cover 810 may be mounted in a first orientation with mounting features 820a and 820b engaging mounting features 840, thereby using cutout 910 in cover 810 to restrict passage way 222 down to opening 920. In one embodiment, cutout 910 may enable interfaces and/or cables to be fed into compartment 720 (e.g., through opening 920) while simultaneously restricting access to compartment 720, thereby increasing the security of items secured within compartment 720. In another embodiment, cutout 910 may inhibit removal of interfaces and/or cables (e.g., with plugs or connectors which will not readily fit through opening 920).

Additionally, cover 810 may be moved vertically with respect to surface 830 (e.g., before mounting cover 810 to surface 830 with mounting features 840). As such, the size of opening 920 may be adjusted (e.g., to account for interfaces and/or cables of different size).

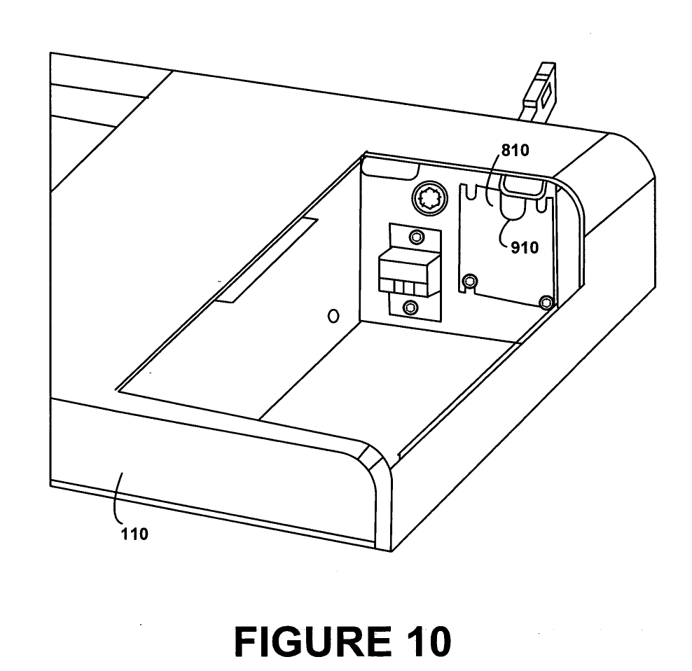

FIG. 10 shows a second exemplary orientation of cover 810 for obscuring access to passage way 222 into compartment 720 in accordance with one embodiment of the present invention. As shown in FIG. 10, cover 810 may be mounted in a second orientation with mounting features 820c and 820d engaging mounting features 840, thereby substantially covering passage way 222 and eliminating opening 920 by reorienting cutout 910 (e.g., rotated 180 degrees with respect to the first orientation shown in FIG. 9). In one embodiment, the second orientation may be used when an interface and/or cable is not routed through passage way 222.

Turning back to FIG. 8, compartment 720 provides access to connector 860 for coupling secured items to interface 240 of FIG. 2. As such, an interface cable (not shown) may be used to couple the secured item to connector 860, thereby enabling the connection of many different devices to interface 240. Although a connector is shown coupled to surface 830 in FIG. 8, it should be appreciated that interface 240 may be alternatively routed into compartment 720 (e.g., via a short cable protruding through surface 830 and terminated in a plug, etc.) in other embodiments. Further, although connector 860 only shows one outlet for coupling a device and/or interface cable, it should be appreciated that a connector with a larger number of outlets may be used in other embodiments.

As shown in FIG. 8, compartment 720 may also provide access to a portion of fastening member 310 of FIG. 3. As such, in one embodiment, door 170 (e.g., for securing a computer display placed within device 100) may be engaged and disengaged (e.g., by tightening nut 870, by inserting a pin in member 310 to prevent removal from housing 110, etc.) from housing 110 only when cover 120 is removed. As such, the lock mechanism (e.g., 130) used to secure cover 120 to housing 110 also effectively secures door 170 to housing 110, thereby reducing the cost and complexity of device 100.

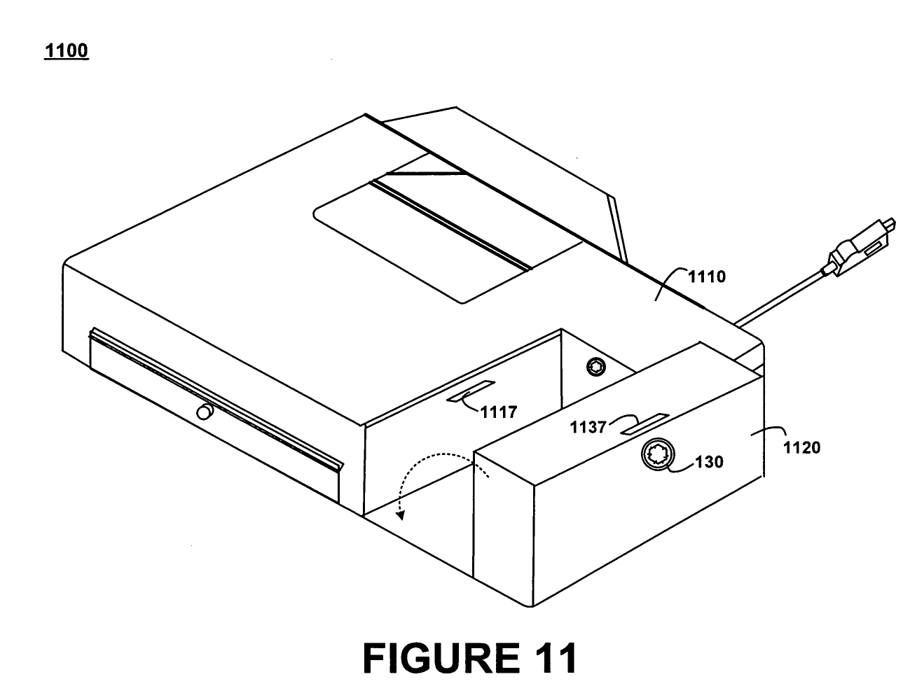

FIG. 11 shows exemplary security device 1100 with a first rotatably-coupled cover for securing items in accordance with one embodiment of the present invention. As shown in FIG. 11, device 1100 may function similarly to device 100 as described above, except that cover 120 is replaced with cover 1120 which is rotatably coupled to housing 1110. As such, items to be secured may be placed on housing 1110 below cover 1120 such that cover 1120 may be rotated down toward housing 1110 (as indicated by the dashed arrow) to limit access to the stored items. Upon aligning engagement feature 1137 in cover 1120 with engagement feature 1117 in housing 1110, the state of lock mechanism 130 may be adjusted to inhibit movement of cover 1120 with respect to housing 1110 (e.g., by extending a lock arm coupled to lock mechanism 130 through both engagement features 1137 and 1117) and secure items stored beneath cover 1120.

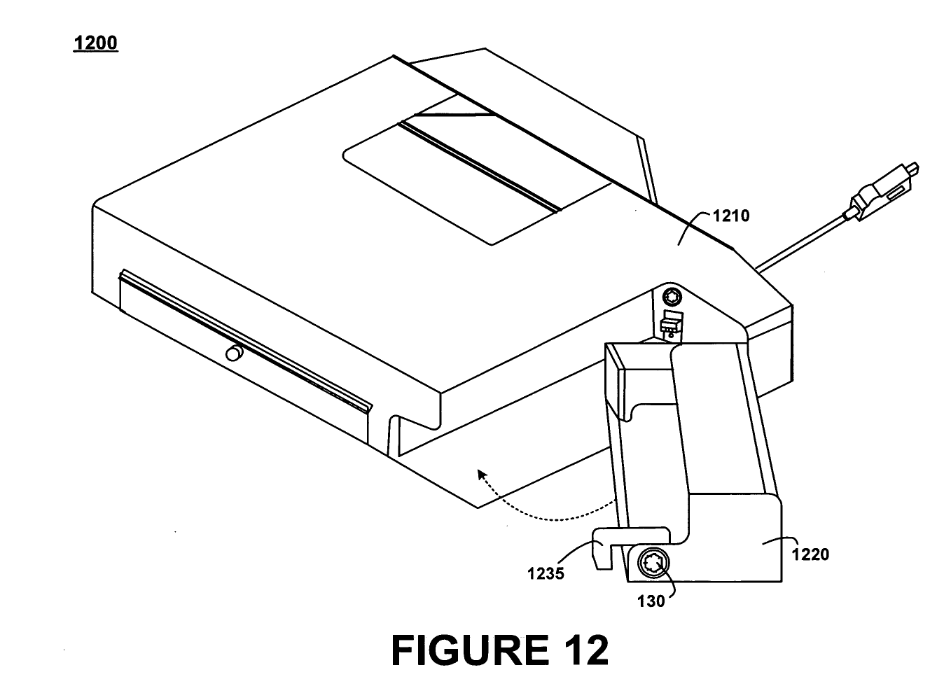

FIG. 12 shows exemplary security device 1200 with a second rotatably-coupled cover for securing items in accordance with one embodiment of the present invention. As shown in FIG. 12, device 1200 may function similarly to device 100 as described above, except that cover 120 is replaced with cover 1220 which is rotatably coupled to housing 1210. As such, items to be secured may be placed within cover 1220 such that cover 1220 may be rotated toward housing 1210 (as indicated by the dashed arrow) to limit access to the stored items. Upon closing cover 1220, the state of lock mechanism 130 may be adjusted to inhibit movement of cover 1220 with respect to housing 1210 (e.g., by rotating lock arm 1235 coupled to lock mechanism 130 until it engages a corresponding engagement feature coupled to housing 1210) and secure items stored within cover 1220.

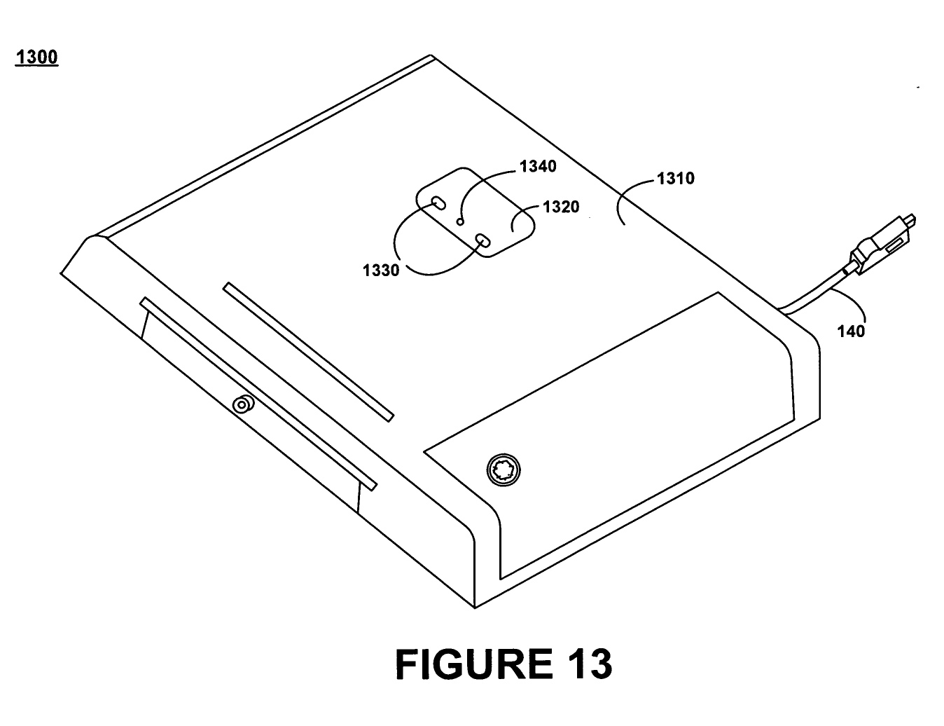

FIG. 13 shows exemplary security device 1300 with a surface for mounting a computer display in accordance with one embodiment of the present invention. As shown in FIG. 13, device 1300 may function similarly to device 100 as described above, except that housing 1310 comprises surface 1320 for mounting a computer display which device 100 does not. Surface 1320 comprises mounting features 1330 and 1340 for interfacing with respective mounting features on a computer display. In one embodiment, mounting features 1330 may comprise slots for accepting features (e.g., hooks, spade tabs, etc.) protruding from a computer display. Mounting feature 1340 may comprise a hole for accepting a fastener (e.g., coupled to a computer display), where a fastening member (e.g., a nut, etc.) may secure the computer display to surface 1320 (e.g., when accessed from the underneath side of surface 1320). And in another embodiment, a fastener may be inserted through mounting feature 1340 from the underneath side to engage a fastening feature (e.g., a nut, etc.) of a computer display being mounted to surface 1320. Alternatively, mounting features 1330 and/or 1340 may comprise at least one hole (e.g., circular, triangular or other polygon-shaped, etc.), slot, feature protruding from surface 1320 for engaging a corresponding feature on a computer display, etc.

Surface 1320 may comprise a universal mounting for mounting various computer displays with different mounting feature arrangements. As such, it should be appreciated that surface 1320 may comprise a different mounting feature arrangement than depicted in FIG. 13 (e.g., comprising features 1330 and 1340). For example, the universal mount may comprise different features than features 1330 and 1340. Additionally, surface 1320 may comprise a larger or smaller number of features in other embodiments.

In one embodiment, surface 1320 may be detachably coupled to housing 1310. As such, the mounting feature arrangement (e.g., 1330 and 1340) may be reconfigured by replacing surface 1320 with surfaces comprising different mounting feature arrangements.

In another embodiment, surface 1320 may accept additional members and/or surfaces for reconfiguring the mounting feature arrangement. For example, an adapter plate with a different mounting feature arrangement than surface 1320 may be mounted to the mounting features of surface 1320 (e.g., in place of a computer display) such that the computer display may then interface with the mounting features of the adapter plate.

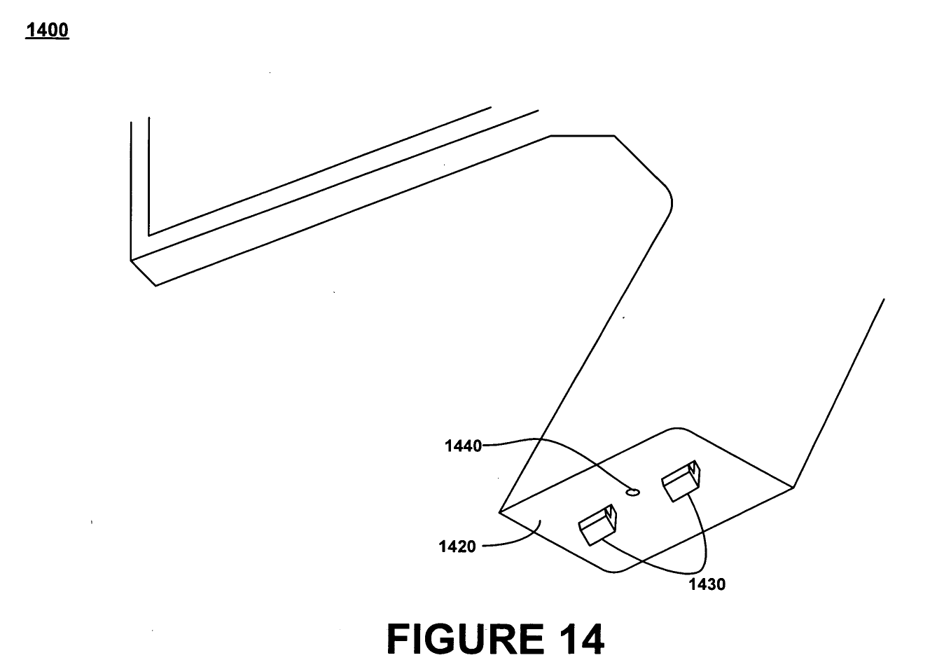

FIG. 14 shows exemplary engagement features of computer display 1400 for interfacing with a surface (e.g., 1320 of FIG. 13) of a security device (e.g., 1300 of FIG. 13) in accordance with one embodiment of the present invention. As shown in FIG. 14, computer display mounting surface 1420 comprises mounting features 1430 and 1440 for interfacing with respective mounting features (e.g., 1330 and 1340) of surface 1320 of FIG. 13. In one embodiment, features 1430 may comprise hooks protruding from surface 1420 for engaging features (e.g., slots, etc.) of surface 1320. In another embodiment, feature 1440 may represent at least one of a hole for accepting a fastener or threads of a fastening member (e.g., a nut, etc.) for aligning with a respective mounting feature of surface 1320 and mounting display 1400 to device 1300.

Although FIG. 14 depicts a specific mounting feature arrangement, surface 1420 may comprise a different mounting feature arrangement in other embodiments. Additionally, mounting surface 1420 may comprise different types of mounting features in addition to or in place of mounting features 1430 and/or 1440. Further, a larger or smaller number of mounting features may be used in other embodiments.

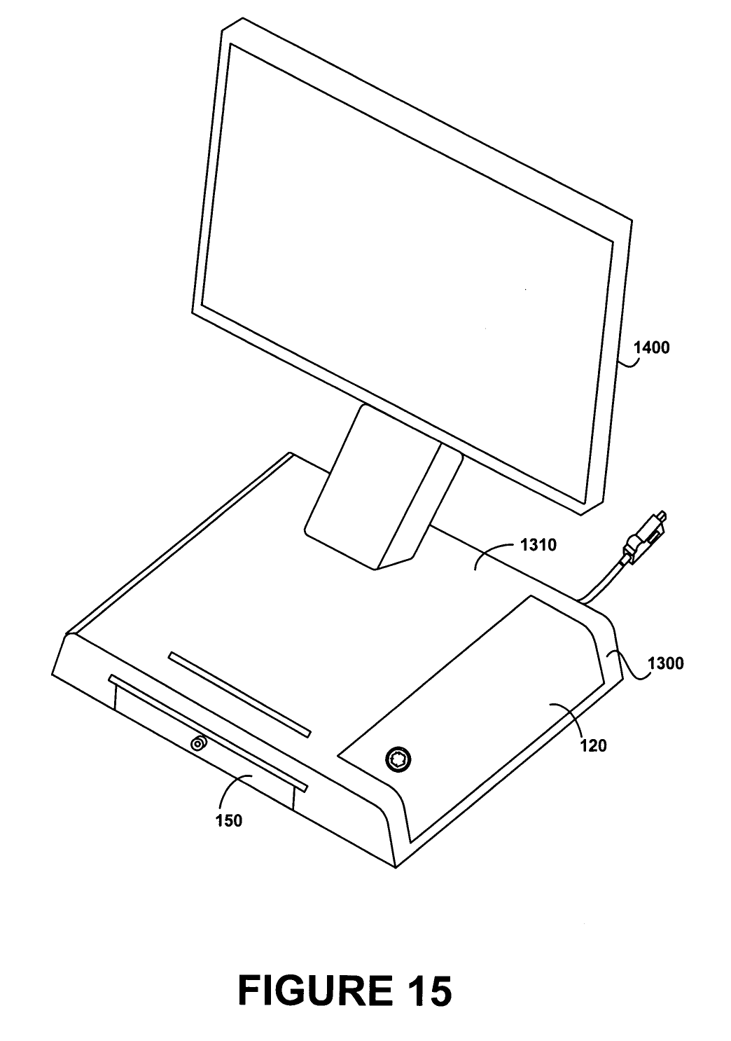

FIG. 15 shows computer display 1400 mounted to exemplary security device 1300 in accordance with one embodiment of the present invention. Display 1400 may be secured to security device 1300 by one or more fastening mechanisms (e.g., interlocking features, fasteners, latches, pins, retaining clips, etc.). As such, device 1300 forms a base for display 1400 when secured thereon.

Display 1400 may be coupled to device 1300 such that release of the display may only be possible upon placing at least one portion of device 1300 in an unsecured state. For example, placing cover 120 and/or drawer 150 in an unsecured state may enable access to a fastening mechanism securing display 1400 to device 1300. Alternatively, placing cover 120 and/or drawer 150 in an unsecured state may automatically enable a release mechanism coupled to the fastening mechanism securing display 1400 to device 1300, thereby enabling display 1400 to be removed from device 1300. And in another embodiment, device 1300 may comprise a feature dedicated to releasing display 1400 from device 1300, where the dedicated feature (e.g., a mechanism coupled to a fastening mechanism securing display 1400 to device 1300, a cover on the underneath side of housing 1310 for providing access to a fastening mechanism securing display 1400 to device 1300, etc.) may be placed in an unsecured state to enable release of display 1400 from device 1300.

Although FIGS. 14 and 15 depict display 1400 with surface 1420 instead of a base (e.g., similar to base 410 of FIG. 4), it should be appreciated that a computer display base may be mounted directly to surface 1320 or a similar surface for accepting such a computer display base in other embodiments.

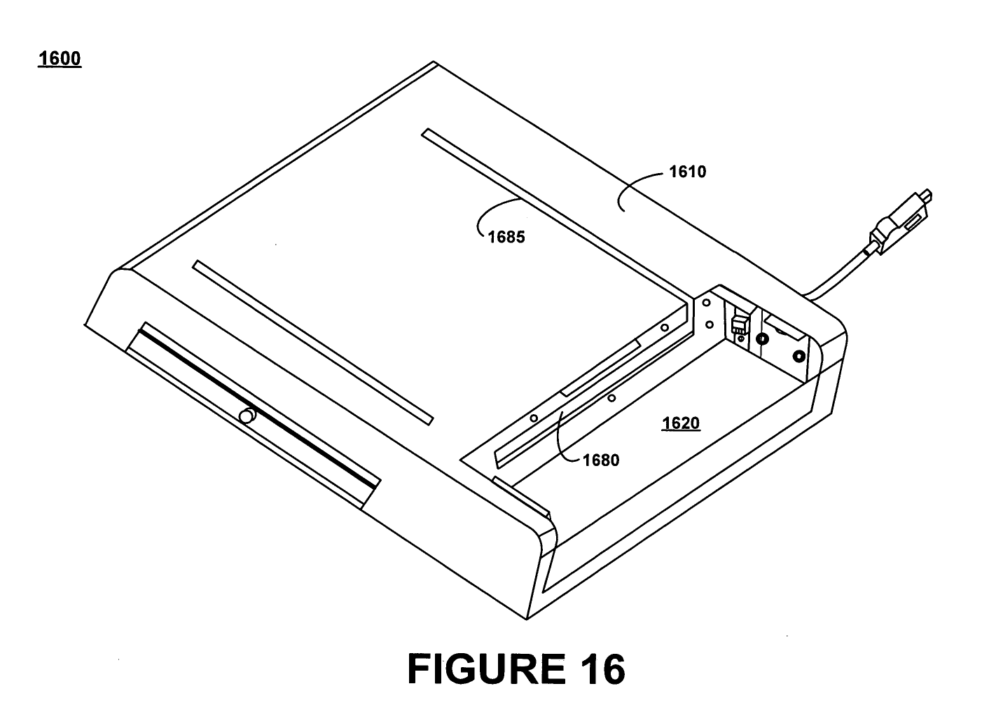

FIG. 16 shows exemplary security device 1600 with a channel for accepting a computer display which is accessible from a compartment of the exemplary security device in accordance with one embodiment of the present invention. As shown in FIG. 16, device 1600 may function similarly to device 100 as described above, except that housing 1610 comprises channel 1680 which device 100 does not. Compartment 1620 enables access to channel 1680 when device 1600 is placed in an unsecured state (e.g., when a cover covering compartment 1620 is unlocked and removed). As such, compartment 1620 serves the multiple purposes of accepting items to be stored and/or secured (e.g., similar to compartment 720 of FIG. 7), as well as enabling access to channel 1680 for placing a computer display base therein. When the computer display base is inserted in channel 1680 of device 1600, the features supporting and/or coupling the display to the display base may protrude from opening 1685.

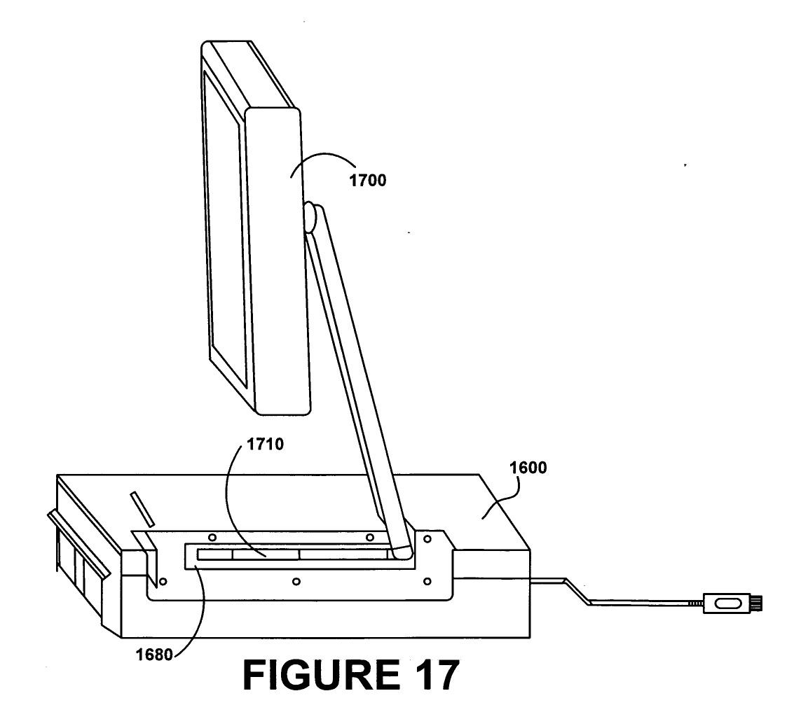

FIG. 17 shows computer display 1700 placed within channel 1680 for accepting the computer display which is accessible from compartment 1620 of exemplary security device 1600 in accordance with one embodiment of the present invention. As shown in FIG. 17, computer display base 1710 may rest on a bottom surface of channel 1680 when placed therein.

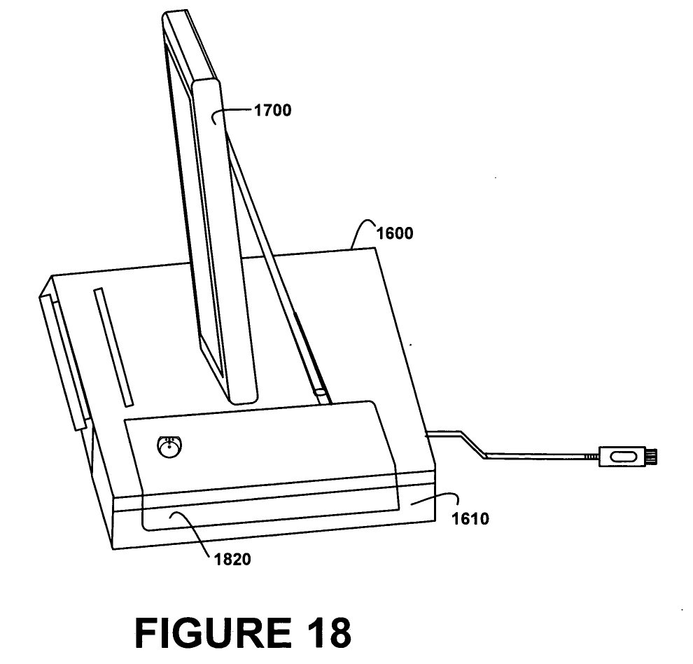

FIG. 18 shows computer display 1800 secured within channel 1680 for accepting the computer display which is accessible from compartment 1620 of exemplary security device 1600 in accordance with one embodiment of the present invention. As shown in FIG. 18, cover 1820 may be placed over compartment 1620 to inhibit removal of display 1700 from device 1600 (e.g., when cover 1820 is engaged to housing 1610 in a secured state). As such, cover 1820 serves the multiple purposes of securing items to be stored and/or secured in compartment 1620 (e.g., similar to cover 120 of FIG. 1), as well as securing display 1700 within device 1600 (e.g., when a state of a lock mechanism for securing the door is adjusted). Accordingly, device 1600 forms a secondary base (e.g., in addition to base 1710) for display 1700 when secured therein.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. An apparatus for securing an item therein, said apparatus comprising:
a housing comprising:
a compartment with an opening for storing said item therein; and
a channel for accepting a portion of a computer display base, said channel comprising a surface for placing said computer display base thereon;
a cover for covering at least a portion of said opening, said cover for limiting physical access to said item when said cover is in contact with said housing; and
a lock mechanism coupled to at least one of said cover and said housing, said lock mechanism operable to secure said item by limiting movement of said cover with respect to said housing.

2. The apparatus of claim 1 further comprising:
a door for covering at least a portion of an opening of said channel; and
a member for engaging said door to said housing and securing said computer display base within said channel.

3. The apparatus of claim 2, wherein said compartment provides access to said member for disengagement of said door from said housing, and wherein said lock mechanism is further operable to secure said computer display base within said channel by limiting access to said member and preventing said disengagement when in a secured state.

4. The apparatus of claim 1, wherein said cover is operable to cover at least a portion of an opening of said channel, said cover further for securing said computer display base within said channel when said lock mechanism is placed in a secured state.

5. The apparatus of claim 1, wherein said item is at least one of a portable computing system and a portable media device.

6. The apparatus of claim 1 further comprising an interface for providing electrical access to said item when in a secured state.

7. The apparatus of claim 6, wherein said interface enables communication with said item by an external device.

8. The apparatus of claim 6, wherein said interface provides power to said item.

9. The apparatus of claim 6, wherein said interface enables transfer of media content accessed by said item.

10. The apparatus of claim 6, wherein said interface enables transfer of data accessed by said item.

11. The apparatus of claim 1 further comprising:
a passage way leading from an outside surface of said housing into said compartment; and
wherein said passage way enables electrical interfaces to be routed into said compartment for coupling to said item.

12. The apparatus of claim 11 further comprising:
a member for obscuring a portion of said passage way and for inhibiting removal of an electrical interface routed within said passage way.

13. The apparatus of claim 1, wherein said cover is rotatably coupled to said housing by a hinge mechanism.

14. The apparatus of claim 1, wherein said housing further comprises a groove for storing a second item thereon.

15. An apparatus for securing an item therein, said apparatus comprising:
a housing comprising:
a channel for accepting a portion of a computer display base, said channel comprising a surface for placing said computer display base thereon; and
a first member for sliding into said housing, said first member comprising a cavity for storage of said item therein; and
a lock mechanism operable to place said first member in a secured state by limiting movement of said first member with respect to said housing, said lock mechanism further for limiting physical access to said item when in said secured state.

16. The apparatus of claim 15 further comprising:
a door for covering at least a portion of an opening of said channel; and
a member for engaging said door to said housing and securing said computer display base within said channel.

17. The apparatus of claim 15, wherein said first member comprises a drawer slidably-coupled with said housing.

18. The apparatus of claim 15, wherein said item comprises a listing of secure information.

19. The apparatus of claim 15, wherein said item is a removable storage device.

20. The apparatus of claim 15, wherein said item is at least one of a portable computing system and a portable media device.

21. A base for a computer display, said base comprising:
a housing comprising:
a surface for mounting a computer display, said surface comprising at least one mounting feature for interfacing with at least one respective mounting feature of said computer display; and
a compartment with an opening for storing an item therein;
a cover for covering at least a portion of said opening, said cover for limiting physical access to said item when in contact with said housing; and
a lock mechanism coupled to at least one of said cover and said housing, said lock mechanism operable to secure said item by limiting movement of said cover with respect to said housing.

22. The base of claim 21, wherein said at least one mounting feature comprises a hole for aligning with said at least one respective mounting feature of said computer display, and wherein said at least one mounting feature and said at least one respective mounting feature are operable to receive a fastener for mounting said computer display to said surface.

23. The base of claim 21, wherein said at least one mounting feature protrudes from said surface and is operable to interlock with said at least one respective feature of said computer display.

24. The base of claim 21, wherein said surface is for coupling to a plurality of displays, wherein each display of said plurality of displays comprises a different mounting feature arrangement.

25. The base of claim 21, wherein said surface is for coupling to a select computer display, wherein said housing is operable to accept other surfaces for coupling to other computer displays, and wherein each of said other computer displays comprises a different mounting feature arrangement.

26. The base of claim 21, wherein said item is at least one of a portable computing system and a portable media device.

27. The base of claim 21 further comprising an interface for providing electrical access to said item when in a secured state.

28. The base of claim 21 further comprising:
a passage way leading from an outside surface of said housing into said compartment; and
wherein said passage way enables electrical interfaces to be routed into said compartment for coupling to said item.

29. The base of claim 28 further comprising:
a member for obscuring a portion of said passage way and for inhibiting removal of an electrical interface routed within said passage way.

30. A base for a computer display, said base comprising:
a housing comprising a surface for mounting a computer display, said surface comprising at least one mounting feature for interfacing with at least one respective mounting feature of said computer display;
a first member for sliding into said housing, said first member comprising a cavity for storage of an item therein; and
a lock mechanism operable to place said first member in a secured state by limiting movement of said first member with respect to said housing, said lock mechanism further for limiting physical access to said item when in said secured state.

31. The base of claim 30, wherein said at least one mounting feature comprises a hole for aligning with said at least one respective mounting feature of said computer display, and wherein said at least one mounting feature and said at least one respective mounting feature are operable to receive a fastener for mounting said computer display to said surface.

32. The base of claim 30, wherein said at least one mounting feature protrudes from said surface and is operable to interlock with said at least one respective feature of said computer display.

33. The base of claim 30, wherein said surface is for coupling to a plurality of displays, wherein each display of said plurality of displays comprises a different mounting feature arrangement.

34. The base of claim 30, wherein said surface is for coupling to a select computer display, wherein said housing is operable to accept other surfaces for coupling to other computer displays, and wherein each of said other computer displays comprises a different mounting feature arrangement.

35. The base of claim 30, wherein said first member comprises a drawer slidably-coupled with said housing.

36. The base of claim 30, wherein said item comprises a listing of secure information.

37. The base of claim 30, wherein said item is a removable storage device.

38. The base of claim 30, wherein said item is at least one of a portable computing system and a portable media device.
